(19) United States
(12) Patent Application Publication
(10) Pub. No.: US 2009/0113397 A1
(43) Pub. Date: Apr. 30, 2009

(54) Dynamic, secure software tagging for software asset management with respect to deployment, configuration, and usage

(75) Inventor: David D. Wright, SR., Santa Cruz, CA (US)

Correspondence Address: HAVERSTOCK & OWENS LLP, 162 N WOLFE ROAD, SUNNYVALE, CA, 94086, US

(73) Assignee: Signetag, Inc.

(21) Appl. No.: 12/288,610

(22) Filed: Oct. 21, 2008

Related U.S. Application Data
(60) Provisional application No. 60/982,563, filed on Oct. 25, 2007.

(51) Int. Cl. G06F 9/44; G06Q 30/00

(52) U.S. Cl. 717/127; 705/34

(57) ABSTRACT

A software tagging application is configured to measure software application usage within an enterprise deployment. The software tagging application using the concepts of tags, and extends the use of tags to convey monitored software usage. This usage data is written to the tag and secured with a signature calculated using public/private key cryptography. The signature ensures that the usage data collected is correct and has not been tampered with. Usage data refers to both the number of client versions of the software and specific software features installed, and any type of metric for monitoring real usage of the specific software features, for example the number of minutes used, and the start and stop times that the feature was executed. Monitoring usage in this manner provides a dynamic usage model that tracks current and historical software usage, from an enterprise-wide level down to a specific user and feature level.

### RELATED APPLICATIONS

This application claims priority of U.S. provisional application Ser. No. 60/982,563, filed Oct. 25, 2007, and entitled “Dynamic, Secure Software Tagging for Software Asset Management with Respect to Deployment, Configuration, and Usage”, by this same inventor. This application incorporates U.S. provisional application Ser. No. 60/982,563 in its entirety by reference.

### FIELD OF THE INVENTION

The invention relates to a method of and apparatus for performing software asset management, and specifically to a method of and apparatus for performing software asset management using software tagging.

### BACKGROUND OF THE INVENTION

In most software deployments, software itself is not actually sold. Instead, software “licenses to use” are sold. The software publisher sells a software purchaser the right to use a fixed unit of utility, for example 10 user licenses. The software purchaser can not use more than the purchased units of utility (10 licenses) because this is the limit that is set by whatever enforcement technology is used, such as providing a license key good for a set number of user licenses. The software purchaser lack the tools to easily ascertain at any given time how many licenses have been deployed and are in use.

Enterprise software applications are frequently deployed using a “trust with tracking” paradigm, which does not use a license enforcement mechanism. The reason being is that large corporations are generally regarded as being trustworthy. As such, software publishers would rather sell their licenses on a Trust with Tracking basis. The only mechanism to determine the actual software usage is to take a detailed inventory of the client software deployments within the enterprise, which is a time consuming, inaccurate, and inefficient exercise.

Increasing requirements to track software assets, because of economic or regulatory reasons, have spawned a whole industry based on SAM (Software Asset Management). Tools are very limited in their ability to track deployment and usage of software in a standard, systematic, and logical fashion. As a result, inspection tools must employ software, platform, and vendor specific installation of “technical software detection” in order to define a deployment. Such tools are complex, difficult to install, and often provide approximate or interpolated deployment data. Additionally, the software publishers use restrictive and ineffective “key” technologies to control usage rather than providing open usage with subsequently published usage information. There is a need for common, persistent, secure, and dynamic software asset and usage identification.

### SUMMARY OF THE INVENTION

The present invention relates to software tagging for software asset management. The objective of the software tagging application is to provide and process secured, dynamic, and persistent tagging of software deployments and subsequent usage. The tags are read by applications and software tools that include, but are not limited to, run-time libraries, processes, and procedures, that can be initiated by a software application or installer/software deployment tool, in order to create or read “tags” for a deployed instance of the software.

Using the software tagging application, at any time the complete combination of individual tags for a deployed software instance includes the current and historical attributes of the deployed software, as well as the attributes of any single deployment instance over time. The software tagging application can be used by Software Asset Management (SAM) Tools, or any other tool allowing open inspection of text at the location of any and all tags, in order to report on deployment, deployment history, usage, usage history, and current deployment status.

In a development and build phase of the software life cycle, the software tagging application is designed to read, process, and use the attributes of an initial “build” tag, which has a description of an entire build process, including all features and metrics. During a deployment phase, a deployment tool deploys the software tagging application as well as places the build tag in a well defined specific location as part of the overall product deployment. The deployment tool can also be configured to install, also in a well defined specific location, a “deployment” tag for use by software tools to understand the dynamic attributes of the deployment.

The software tagging application is also configured to process and use the attributes of a “usage” tag. During a usage phase of the software, the software tagging application installs and in some cases removes, in and from a well defined specific location, usage tags describing the attributes of usage, such as features being used, meter, model, etc. The build, deployment, and usage tag creation and removal is indexed/logged in a “Secure Tag Index” allowing an accumulation of deployment and usage history over time.

The software tagging application is also configured to examine tags periodically, during run-time, in order to ensure the tags have neither been tampered with nor removed. In some embodiments, the software tagging application is programmed with policy on action, should tags be missing or unreadable. The software can use any policy embedded in any tag on the action to be performed should the tag be found corrupt or altered in any way, assuming the tag can be read. In some embodiments, the software tagging application is configured to interface with an external inspection tool, for example a SAM tool, such that the external inspection tool is configured to perform the same examination of the tag index and all tag types, and use the attributes of all three tag types, for reporting and other software management purposes. The software tagging application is configured to be implemented across mixed and multiple different software platforms. In some cases, one or more of the different software platforms may require a platform specific implementation.

Other features and advantages of the present invention will become apparent after reviewing the detailed description of the embodiments set forth below.

### BRIEF DESCRIPTION OF THE DRAWINGS

FIG. 1 illustrates an exemplary deployment 10 of an enterprise software application.

FIG. 2 illustrates a block diagram of the internal components of an exemplary computing device implementing a client version of the deployed enterprise software application.

FIG. 3 illustrates an exemplary management tool for accessing the tags and usage data stored in the tag database.

FIG. 4 illustrates exemplary usage data and signature corresponding to the usage tag 124 of FIG. 3.

FIG. 5 illustrates another exemplary management tool for accessing the tags stored in the tag database.

FIG. 6 illustrates an exemplary method of using the software tagging application to measure software application usage within an enterprise deployment.

The present invention is described relative to the several views of the drawings. Where appropriate and only where identical elements are disclosed and shown in more than one drawing, the same reference numeral will be used to represent such identical elements.

### DETAILED DESCRIPTION OF THE PRESENT INVENTION

Reference will now be made in detail to the embodiments of the software tagging application of the invention, examples of which are illustrated in the accompanying drawings. While the invention will be described in conjunction with the embodiments below, it will be understood that they are not intended to limit the invention to these embodiments and examples. On the contrary, the invention is intended to cover alternatives, modifications and equivalents, which may be included within the spirit and scope of the invention as defined by the appended claims. Furthermore, in the following detailed description of the present invention, numerous specific details are set forth in order to more fully illustrate the present invention. However, it will be apparent to one of ordinary skill in the prior art that the present invention may be practiced without these specific details. In other instances, well-known methods and procedures, components and processes haven not been described in detail so as not to unnecessarily obscure aspects of the present invention.

Embodiments of the present invention are directed to a software tagging application configured to measure software application usage within an enterprise deployment. The software tagging application using the concepts of tags, and extends the use of tags to convey monitored software usage. As used herein, the term “tag” refers to a data file or container that includes attributes about a client version of the software application deployed on a specific computing device within the enterprise. As also used herein, the term “tagging” refers to the use of tags, and associating a specific tag to a specific deployed client version of the software application. The software tagging application uses tags to measure the actual deployment and usage of the deployed software application directly from the product set, that is directly from the client versions of the software application deployed on the computing devices. Each tag includes a set of static attributes, and in some cases a set of dynamic attributes. The dynamic attributes are dynamically determined and written onto the tag at the computing device.

This usage data is written to the tag and secured with a signature calculated using public/private key cryptography. The signature ensures that the usage data collected is correct and has not been tampered with. Usage data refers to both the number of client versions of the software and specific software features installed, and any type of metric for monitoring real usage of the specific software features, for example the number of minutes used, and the start and stop times that the feature was executed. Monitoring usage in this manner provides a dynamic usage model that tracks current and historical software usage, from an enterprise-wide level down to a specific user and feature level.

A client version of the software application is installed on each of a plurality of computing devices within the enterprise. Each local instantiation of the software application is understood to include one or more licensable offerings. A licensable offering may be associated with a particular single usage feature of the software application, or a combination of features. A tag is defined for each licensable offering. For each enterprise software application deployment, any number of different metrics are defined. Each metric has a corresponding tag, each of which can be deployed to one, some, or all of the computing devices within the enterprise. Each tag includes one or more features of the software application that are to be tracked. Any number of other attributes can also be included in the tag. As the software is deployed throughout the enterprise, one, some, or all of the tags are deployed at each computing device. In some embodiments, each computing device includes at least one tag, this minimum one tag indicates the type of computing device, such as a client, a server, or some other identifier. Other tags are used to track usage (metrics) related to specific features of the software application.

When a feature is executed by a user, the corresponding tag is deployed, or transmitted, to a tag repository accessible by a tag management module. Alternatively, tags are transmitted on a periodic basis, providing periodic metrics as to the usage of the software features. The frequency of these calls (transmissions) to the tag repository is completely flexible and is determined as a parameter of the software tagging application. The collection of usage tags in the tag repository provides a histogram of usage and software deployment over time. Usage data corresponding to the executed usage feature is written into the tag prior to it's transmission from the local computing device. The deployed tag including the usage data is referred to as a usage tag. The usage tag itself functions similarly to a bar code affixed to a specific computing device, except in the software tagging application the bar code is transmitted from the computing device to the tag repository.

The usage data can include any usage metric associated with the corresponding executed feature. For example, the usage data can simply indicate that the user is now using the executed feature, or the usage data can indicate the start time at which the feature was executed. A subsequent usage tag can then indicate the stop time at which the feature was closed. In some embodiments, a usage tag is transmitted from the local computing device at the time the corresponding feature is executed. In other words, transmission of the usage tag is event driven. A subsequent usage tag can be transmitted once execution of the feature is terminated. In other embodiments, the usage tag is transmitted on a periodic basis, whether or not the corresponding feature has been executed. In this case, the usage tag provides a periodic status check of the corresponding feature at the local computing device. It is understood that any type of features, usage data, and usage tag transmission events can be used to identify and measure the various functions of a deployed software application.

The software tagging application also provides functionality to ensure the usage data is genuine and has not been tampered with. After the usage data is written to the tag, the local computing device generates a signature associated with the usage data, and the signature is also written to the tag. The signature is calculated using the usage data and public/private key cryptography that is well known in the art. The signature is calculated using a private key, and a public key is transmitted with the usage tag. At a receiving end, the public key is applied to the signature to generate the signed usage data, which is then compared to the usage data written into the tag. If the two match, then the usage data is genuine, thereby ensuring indisputable evidence of usage. If the two do not match, then the usage data is determined to be corrupt or altered. Appropriate action can then be undertaken.

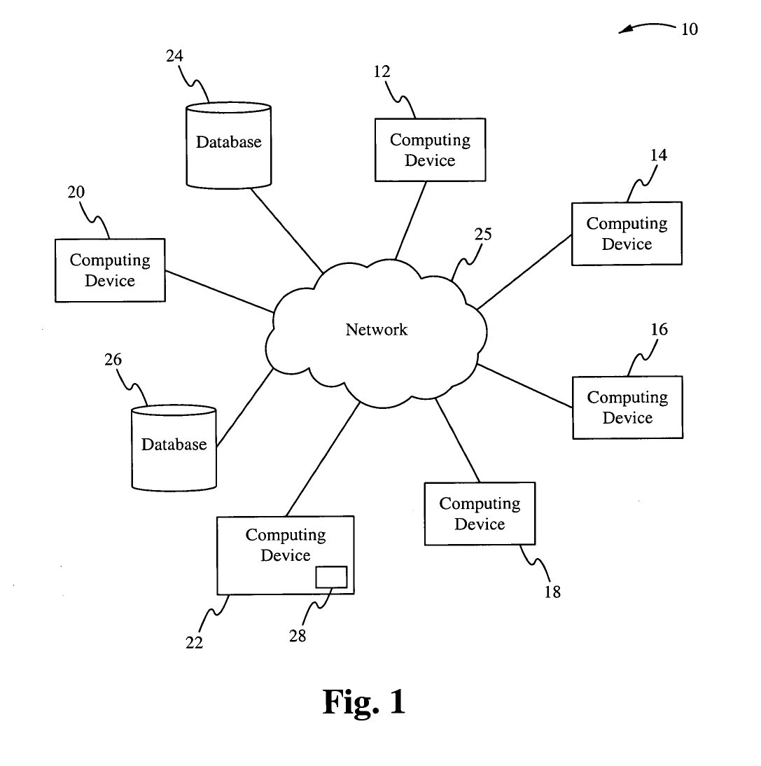

FIG. 1 illustrates an exemplary deployment 10 of an enterprise software application. A plurality of computing devices 12, 14, 16, 18, 20, and 22 are each coupled to a communications network 25. Any of the computing devices can be used as a database, and/or one or more separate databases, such as databases 22 and 24, are also coupled to the network 25. A client verison of the software application is installed on each of the computing devices 12-22. Included with the client verison is a plurality of tags, each tag defining one or more features of the software application that are to be tracked. When such a feature is executed by a user of one of the computing devices, appropriate usage data is written to the tag corresponding to the executed feature. A signature is also written to the tag to be later used to verify the authenticity of the usage data. The signature is calculated using a private key. The usage data written to the tag is clear and not encrypted. The tag including the written usage data and signature forms a usage tag, which is transmitted to a tag repository configured in one or more of the databases 24, 26. The tag repository uses a verifying application to verify the authenticity of each received usage tag before accepting and storing the usage tag.

A management module is installed on one or more of the computing devices, such as management module 28 installed on the computing device 22 in FIG. 1. The management module 28 includes software asset management tools for tag management and access to the usage data stored in the tag repository. The number of computing devices and databases shown in the network of FIG. 1 is for exemplary purposes only. In many enterprise software deployments, there are hundreds if not thousands of instantiations of the local software application installed on computing devices.

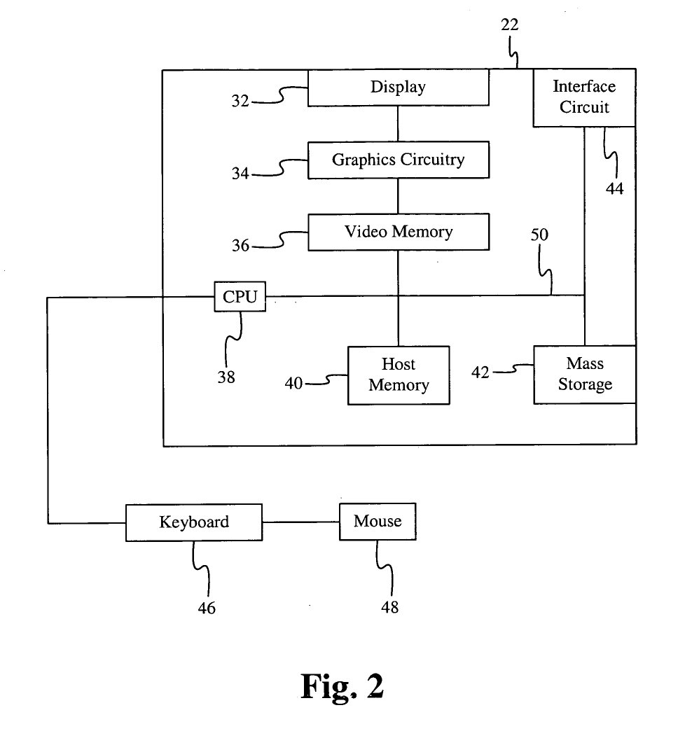

FIG. 2 illustrates a block diagram of the internal components of an exemplary computing device implementing the client version of the deployed enterprise software application. The exemplary computing device shown in FIG. 2 can also be used to install the software tagging application management tool, such as the management module 28 installed on the computing device 22 of FIG. 1. As shown in FIG. 2, the computing device 22 includes a central processor unit (CPU) 38, a host memory 40, a video memory 36, a mass storage device 42, and an interface circuit 44, all coupled together by a conventional bidirectional system bus 50. The interface circuit 44 preferably includes a physical interface circuit for sending and receiving communications over a communications network. In one embodiment, the interface circuit 44 is implemented on an ethernet interface card within the computing device 22. However, it should be apparent to those skilled in the art that the interface circuit 44 can be implemented within the computing device 22 in any other appropriate manner, including building the interface circuit onto the motherboard itself. The mass storage device 42 can include both fixed and removable media using any one or more of magnetic, optical or magneto-optical storage technology or any other available mass storage technology. The system bus 50 enables access to any portion of the memory 40 and 42 and data transfer between and among the CPU 38, the host memory 40, the video memory 36, and the mass storage device 42. Host memory 40 functions as system main memory, which is used by CPU 38. The management tool 28 (FIG. 1) is executed by the CPU 38 and stored in the host memory 40 and/or the mass storage 42.

The computing device 22 is also coupled to a number of peripheral input and output devices including a keyboard 46, a mouse 48, and an associated display 32. The keyboard 46 is coupled to the CPU 38 for allowing a user to input data and control commands into the computing device 22. The mouse 48 is coupled to the keyboard 46, or coupled to the CPU 38, for manipulating graphic images on the display 32 as a cursor control device, and in particular for accessing the management tool via the GUI on the display 32. The computing device 22 includes graphics circuitry 34 to convert data into signals appropriate for display. It is understood that the configuration of computing device 22 shown in FIG. 2 is for exemplary purposes only and that computing device 22 can be configured in any other conventional manner.

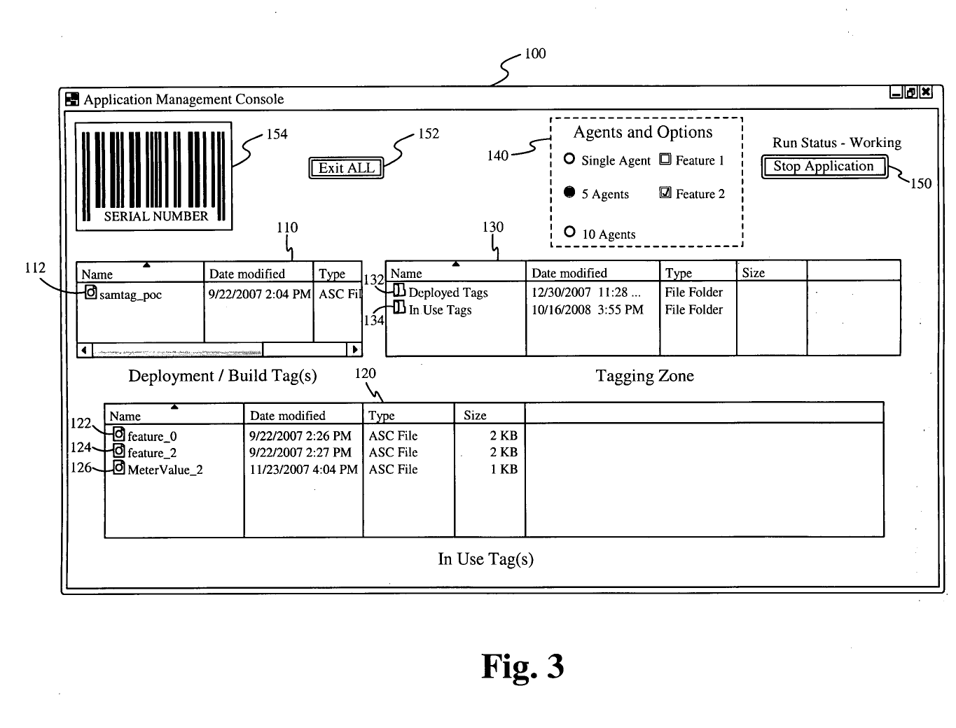

In some embodiments, the management module 28 (FIG. 1) includes a management tool and a discovery tool. FIG. 3 illustrates an exemplary management tool for accessing the tags and usage data stored in the tag repository. The exemplary screen shot shown in FIG. 3 illustrates an application management tool 100, which includes a build and deployment tags box 110, an in-use tags box 120, and a tag compilation box 130. The build and deployment tags box 110 includes a list of build tags and deployment tags, such as tag 112, deployed within the enterprise. In a development and build phase of the software life cycle, the software tagging application is designed to read, process, and use the attributes of an initial build tag, which has a description of an entire build process, including all features and metrics. The type of data included in a build tag can include, but is not limited to, software ID, language, license type, manufacturer, part number, tag version, product, product version, platform, abstract, available features/components and versions, signature, public key, and verification policy.

During a deployment phase, a deployment tool deploys the software tagging application as well as places the build tags in a well defined specific location as part of the overall product deployment. The deployment tool can also be configured to install, also in a well defined specific location, one or more deployment tags for use by software tools to understand the dynamic attributes of the deployment. The type of data included in a deployment tag can include, but is not limited to, software ID, deployment reference number, data and time of deployment, deployment tool type, packager, sign-off information, release (identifies release version of the feature offering being deployed), release roll out, release verification, platform abstract, signature, public key, and verification policy. For subsequent product updates or upgrades, additional build tags and deployment tags are added. However, any previous build tags and deployment tags remain.

The in-use tags box 120 includes a list of usage tags, such as tags 122, 124, and 126, indicating features currently in use by the computing devices within the enterprise software deployment. The usage tags displayed in the in-use tags box 120 provide a current snapshot of enterprise software usage at the current time. The usage tags 122, 124, 126 include usage data written to different types of tags. Each tag specifies one or more specific software application features that when executed by the user are tracked and written as usage data onto the tag. A signature is also added to the tag, thereby forming a usage tag including the signature and usage data associated with the specific one or more software application features.

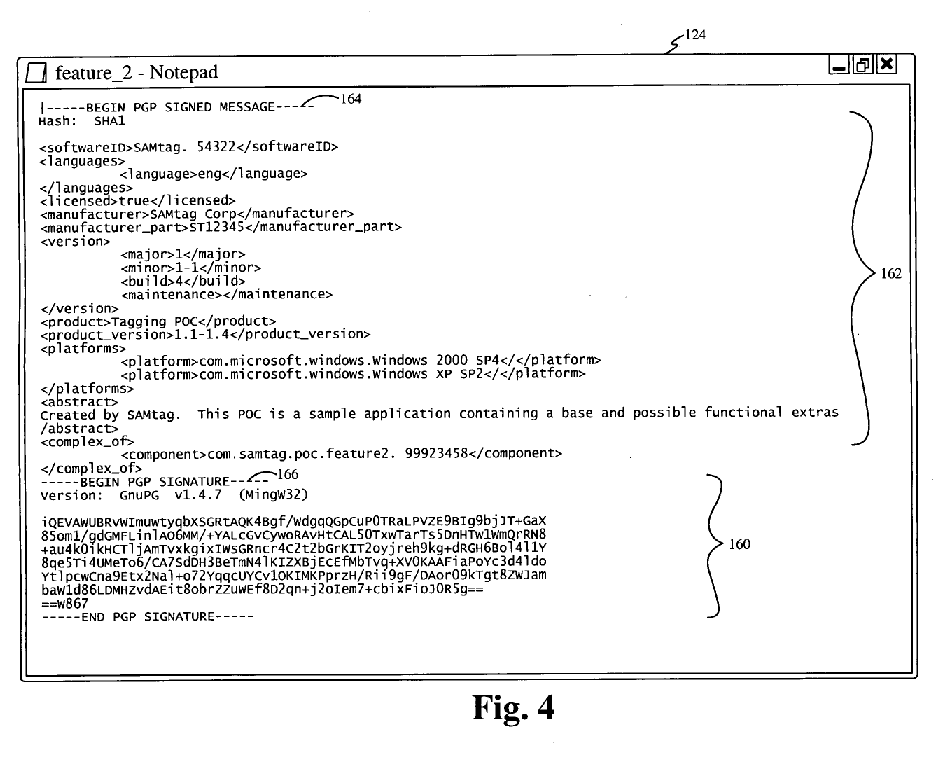

FIG. 4 illustrates exemplary usage data and signature corresponding to the usage tag 124 of FIG. 3. The usage tag 124 is configured as an ASCII file and includes usage data 162 and a signature 160. The signature 160 is calculated using the usage data 162 and the private key associated with the local computing device from which the usage data was collected. The usage data is defined by a usage data start marker 164 and a usage data end marker 166. Although not shown in FIG. 4, a usage tag can include other data. In some embodiments, this additional data is signed. In other embodiments, this additional data is not signed and therefore does not come with a verification of authenticity. The type of additional data included in the usage tag can include, but is not limited to, software ID, feature ID(s), feature version(s), usage meter/model, temporal attributes such as date stamp, abstract, public key, and verification policy. The data and format of the usage data 162 shown in FIG. 4 is for exemplary purposes only, and is not restrictive of the type, amount, and format of the usage data that can be written to a usage tag, or the number of features for which usage data is provided. Further, although the usage tag 124 is described as including a single signature associated with a single set of usage data, a usage tag can have multiple signatures for multiple groups of attributes.

Referring back to FIG. 3, the usage tag 122 is labeled as “feature_{—}0” and correspond to a base feature provided by the software application. Inclusion of the tag 122 in the in-use tags box 120 indicates that feature_0 is currently being used by one of the computing devices in the enterprise. Similarly, the usage tag 124 is labeled as “feature_{—}2” and correspond to a second feature provided by the software application. Inclusion of the tag 124 in the in-use tags box 120 indicates that feature_2 is currently being used by one of the computing devices in the enterprise. Feature_0 and feature_2 may or may not correspond to the same computing device, that level of detail is provided in the usage data of the tags 122 and 124. In this exemplary case, the tags 122 and 124 indicate that feature_0 and feature_2 are running. The usage tag 126 is labeled as “MeterValue_{—}2” and corresponds to a usage metric associated with the running of feature_2.

In general, tags are configured as either static tags or dynamic tags. A static tag has one or more metrics preprogrammed into it. For example, the build tags and deployment tags are static tags, such as the tag 112. Certain usage tags are configured as static tags, for example the usage tag 122, which indicates that feature_0 was used, and the usage tag 124, which indicates that feature_2 was used. A dynamic tag indicates usage data representative of specific usage during a period of time. The dynamic tag not only indicates usage at a point in time, as with the static tag, but also indicates the usage over time, which is dynamic. This dynamic usage effectively provides a log of activities. The time changing information is signed in real time.

The tag compilation box 130 includes a compilation of the tags deployed with the enterprise software application, organized by type. In the example shown in FIG. 3, the tags are organized as “Deployed Tags” an “In Use Tags”. The Deployed Tags include a list of those tags deployed within the enterprise, to which usage data is written and sent as usage tags. The In Use Tags includes a list of those tags currently in use, which in this case corresponds to the usage tags listed in the in-use tags box 120.

The Agents and Options box 140 provides additional administrative function. One such function is to select the number of users (agents) that are anticipated to use the software application at the current time. In this exemplary case, the administrator can select between “Single Agent”, “5 Agents”, and “10 Agents”. Selection of “Single Agent” anticipates relative low use of the software. Selection of “10 Agents” anticipates relative high use. Selection of different use levels essentially reserves processing bandwidth in anticipation of a certain level of user activity. Another administrative function is to select a specific feature(s) to track current usage. In this exemplary case, “feature_{—}2” is selected, and any usage associated with “feature_{—}2” is indicated in the in-use tags box 120. It is understood that the Agents and Options box 140 can include more, or less, than the three agent and two feature selections shown.

A start/stop application button 1 50 is used to stop and start the application management tool. In the current state shown in FIG. 3, the application management tool is running, as indicated by the “Run Status—Working” description provided above the start/stop application button 150. While in the running state, the start/stop application button 150 shows “Stop Application” to indicate the function that will be performed upon pressing the button. Once stopped, the start/stop application button 150 shows “Start Application”.

Image 154 is for aesthetics only and does not provide functionality. An exit button 152 closes the application management tool.

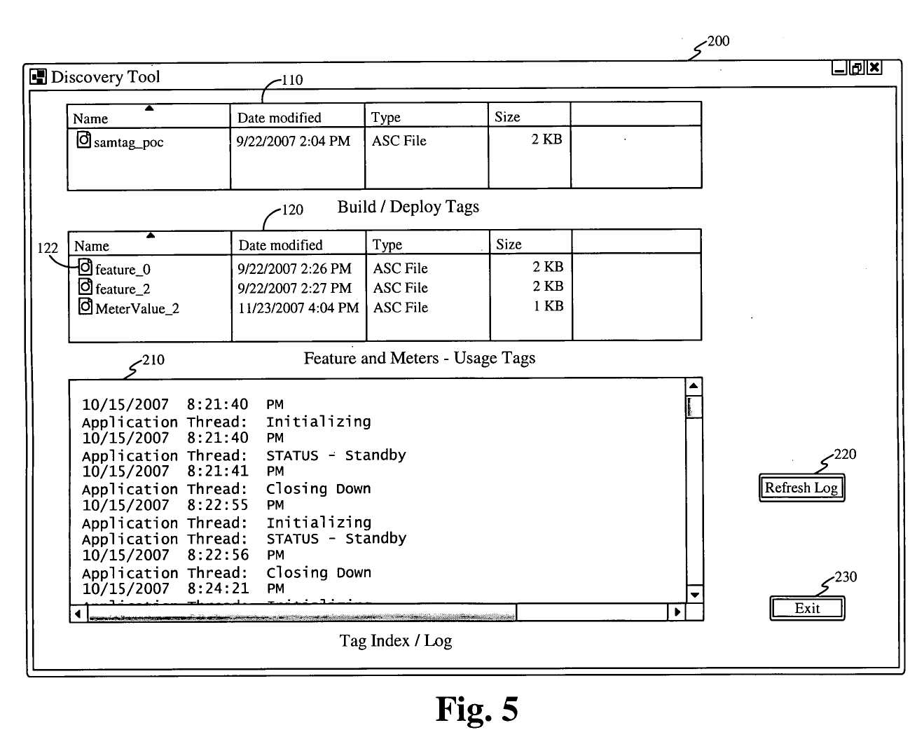

FIG. 5 illustrates another exemplary management tool for accessing the tags stored in the tag database. The exemplary screen shot shown in FIG. 5 illustrates a discovery tool 200, which includes the same build and deployment tags box 110 and the usage tags box 120 of the application management tool 100 in FIG. 3. The discovery tool 200 also includes a tag index box 210 that shows a log of all current and historical usage data associated with a specific type of tag, across the entire enterprise software deployment. To access the log information of a specific tag, a tag is selected from either the box 110 or the box 120. For example, if the usage tag 122 is selected in the box 120, the usage data from all usage tags of the type of usage tag 122, sent from all computing devices in the enterprise software deployment, are displayed in the log 210. The button 220 is used to refresh the log 210 associated with the selected tag. The button 230 exits the discovery tool 200.

Although the management module is described as including two tools, the management tool of FIG. 3 and the discovery tool of FIG. 5, the management module is not restricted to these two tools. It is contemplated that any tool can be developed that enables deployment of tags within the enterprise, management of the deployed tags, and accessing and manipulating the usage data stored in the tag repository.

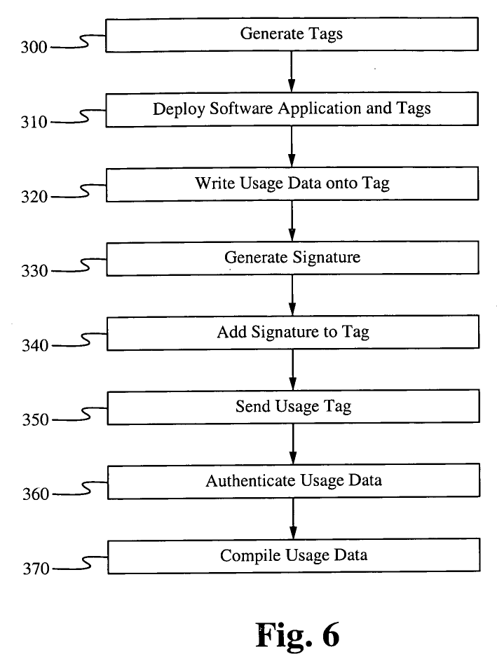

FIG. 6 illustrates an exemplary method of using the software tagging application to measure software application usage within an enterprise deployment. At the step 300, a plurality of tags is generated. Each tag defines one or more usage features associated with an enterprise software application. At the step 310, the enterprise software application is deployed within a plurality of computing devices such that a client application and one or more tags are installed on each computing device. At the step 320, usage data is written onto the tag. The usage data corresponds to an executed usage feature on one of the computing devices. At the step 330, a signature is generated using the usage data and private/public key cryptography. At the step 340, the signature is added to the usage tag. A tag including the written usage data and signature forms a usage tag. At the step 350, the usage tag is sent to a tag repository. At the step 360, the authenticity of the usage data written in the usage tag is verified using the signature. At the step 370, the usage tags sent from the plurality of computing devices are compiled to generate current and historical usage metrics of the deployed enterprise software application.

The software tagging application is used as a Software Asset Management tool to manage the deployment of an enterprise software application. The software tagging application can also be used to reconcile actual usage against entitlement packages, or licensing models, purchased for use within the enterprise.

The software tagging application also provides a means for enabling a usage-based and feature-based pricing model, where a bill is provided based on actual usage. This contrasts to bulk pricing models where a block of feature licenses are purchased prior to use.

Although described above in terms of a single enterprise software application, the software tagging application is configured for use across multiple different platforms and can be used to manage the deployment of multiple different enterprise software applications.

The present invention has been described in terms of specific embodiments incorporating details to facilitate the understanding of the principles of construction and operation of the invention. Such reference herein to specific embodiments and details thereof is not intended to limit the scope of the claims appended hereto. It will be apparent to those skilled in the art that modifications may be made in the embodiment chosen for illustration without departing from the spirit and scope of the invention.

What is claimed is:

1. A method of measuring software application usage within an enterprise deployment, the method comprising:
a. generating a plurality of tags, each tag defines one or more usage features associated with an enterprise software application;
b. deploying the enterprise software application within a plurality of computing devices such that a client application and one or more tags are installed on each computing device;
c. writing usage data onto the tag, wherein the usage data corresponds to an executed usage feature on one of the computing devices, thereby generating a usage tag;
d. sending the usage tag to a tag repository; and
e. compiling the usage tags sent from the plurality of computing devices to generate current and historical usage metrics of the deployed enterprise software application.

2. The method of claim 1 further comprising verifying an authenticity of the usage data written into the usage tag.

3. The method of claim 2 wherein verifying the authenticity of the usage data comprises:
a. generating a signature using the usage data and a private/public key cryptography;
b. adding the signature to the usage tag before sending the usage tag; and
c. at a receiving location, verifying the authenticity of the usage data written in the usage tag using the signature.

4. The method of claim 3 wherein the signature is generated at the computing device that executed the usage feature.

5. The method of claim 1 further comprising periodically generating a bill to be paid based on the compiled usage metrics.

6. The method of claim 1 wherein the client application on each computing device is installed for open usage without using a software license key.

7. The method of claim 1 wherein the usage tag is sent after execution of the usage feature.

8. The method of claim 1 wherein the usage data is written to the tag and the usage tag is sent on a periodic basis.

9. The method of claim 1 wherein the usage data comprises a metric associated with executed feature.

10. The method of claim 1 wherein the usage tag comprises a static tag including a predetermined metric value.

11. The method of claim 1 wherein the usage tag comprises a dynamic tag including a metric value determined in real time.

12. The method of claim 1 wherein the compiled usage metrics define a number of users authorized to use each defined feature of the software application.

13. The method of claim 1 wherein the compiled usage metrics define real-time usage of each defined usage feature in the software application.

14. The method of claim 1 wherein the compiled usage metrics form an activity log for each defined usage feature.

15. A computer readable medium including program instructions for execution by a plurality of processing units within a plurality of networked computing devices, which when executed by the plurality of processing units, causes the plurality of networked computing devices to perform:
a. generating a plurality of tags, each tag defines one or more usage features associated with an enterprise software application;
b. deploying the enterprise software application within the plurality of computing devices such that a client application and one or more tags are installed on each computing device;
c. writing usage data onto the tag, wherein the usage data corresponds to an executed usage feature on one of the computing devices, thereby generating a usage tag;
d. sending the usage tag to a tag repository; and
e. compiling the usage tags sent from the plurality of computing devices to generate current and historical usage metrics of the deployed enterprise software application.

16. The computer readable medium of claim 15 further comprising verifying an authenticity of the usage data written into the usage tag.

17. The computer readable medium of claim 16 wherein verifying the authenticity of the usage data comprises:
a. generating a signature using the usage data and a private/public key cryptography;
b. adding the signature to the usage tag before sending the usage tag; and
c. at a receiving location, verifying the authenticity of the usage data written in the usage tag using the signature.

18. The computer readable medium of claim 17 wherein the signature is generated at the computing device that executed the usage feature.

19. The computer readable medium of claim 15 further comprising periodically generating a bill to be paid based on the compiled usage metrics.

20. The computer readable medium of claim 15 wherein the client application on each computing device is installed for open usage without using a software license key.

21. The computer readable medium of claim 15 wherein the usage tag is sent after execution of the usage feature.

22. The computer readable medium of claim 15 wherein the usage data is written to the tag and the usage tag is sent on a periodic basis.

23. The computer readable medium of claim 15 wherein the usage data comprises a metric associated with executed feature.

24. The computer readable medium of claim 15 wherein the usage tag comprises a static tag including a predetermined metric value.

25. The computer readable medium of claim 15 wherein the usage tag comprises a dynamic tag including a metric value determined in real time.

26. The computer readable medium of claim 15 wherein the compiled usage metrics define a number of users authorized to use each defined feature of the software application.

27. The computer readable medium of claim 15 wherein the compiled usage metrics define real-time usage of each defined usage feature in the software application.

28. The computer readable medium of claim 15 wherein the compiled usage metrics form an activity log for each defined usage feature.

29. A computing system to measure software application usage within an enterprise software application deployment, the computing system comprising:
a. a communications network;
b. a plurality of computing devices coupled to the network, wherein each of the computing devices includes a client application of the enterprise software application and one or more tags, further wherein each tag defines one or more usage features associated with the enterprise software application, wherein the client application is configured to write usage data onto the tag, the usage data corresponds to an executed usage feature on the computing device, thereby generating a usage tag, and to transmit the usage tag; and
c. a tag repository coupled to the communication network, where the tag repository is configured to store the usage tags received from each of the plurality of computing devices, and to compile the received usage tags to generate current and historical usage metrics of the deployed enterprise software application.

30. The computing system of claim 29 wherein the tag repository includes a verification module configured to verify an authenticity of the usage data written into the usage tag.

31. The computing system of claim 29 wherein each client application is configured to generate a signature using the usage data and a private/public key cryptography, and to add the signature to the usage tag before sending the usage tag.

32. The computing system of claim 31 wherein the tag repository includes a verification module configured to verify the authenticity of the usage data written in the usage tag using the signature.

33. The computing system of claim 29 wherein the client application on each computing device is configured for open usage without using a software license key.

34. The computing system of claim 29 wherein the client application is configured to send the usage tag after execution of the usage feature.

35. The computing system of claim 29 wherein the client application is configured to write the usage data to the tag and to send the usage tag on a periodic basis.

36. The computing system of claim 29 wherein the usage data comprises a metric associated with executed feature.

37. The computing system of claim 29 wherein the usage tag comprises a static tag including a predetermined metric value.

38. The computing system of claim 29 wherein the usage tag comprises a dynamic tag including a metric value determined in real time.

39. The computing system of claim 29 wherein the compiled usage metrics define a number of users authorized to use each defined feature of the software application.

40. The computing system of claim 29 wherein the compiled usage metrics define real-time usage of each defined usage feature in the software application.

41. The computing system of claim 29 wherein the compiled usage metrics form an activity log for each defined usage feature.
